(19) United States
(12) Patent Application Publication
(10) Pub. No.: US 2007/0172337 A1
(43) Pub. Date: Jul. 26, 2007

(54) Containment of drilling waste material

(76) Inventors: Neale Browne, Houston, TX (US); Catalin Ivan, Sugar Land, TX (US)

Correspondence Address: CARTER J. WHITE LEGAL DEPARTMENT;M-I L.L.C., 5950 NORTH COURSE DRIVE, HOUSTON, TX, 77072, US

(21) Appl. No.: 11/340,091

(22) Filed: Jan. 26, 2006

(51) Int. Cl. B65G 1/00

(52) U.S. Cl. 414/332

(57) ABSTRACT

A method for containing drilling waste comprising moving the drilling waste comprising drill cuttings in a container so as to prevent at least a substantial portion of the drill cuttings from adhering to the inside surface of the container. The drilling waste may include drilling fluid, oil, water, drill cuttings, or other substances. The drilling waste may be moved by any means and in any fashion. For example, the container may be rotated to tumble the drilling waste inside. The method may be performed at any location, including at the drilling site or processing facility. The method may also be used during transportation of the drilling waste.

### BACKGROUND OF INVENTION

In the drilling of oil and gas wells, a drill bit is used to dig many thousands of feet into the earth's crust. Oil rigs typically employ a derrick that extends above the well drilling platform and that supports joint after joint of drill pipe connected end to end during the drilling operation. The drill pipe or “drill string” thus comprises a plurality of joints of pipe, each of which has an internal, longitudinally extending bore. The drill string bore carries drilling fluid, or “drilling mud”, from the well drilling platform through the drill string and to a drill bit supported at the lower, or distal, end of the drill string.

The drilling mud lubricates the drill bit and carries away small pieces of shale and rock, or “cuttings”, generated by the drill bit as it digs deeper. The cuttings are carried in a return flow stream of drilling fluid through the well annulus and back to the well drilling platform at the earth's surface. At the surface, the drill cuttings are typically separated from the reusable drilling fluid with commercially available separators that are known as “shale shakers”. Some shale shakers are designed to filter coarse material from the drilling mud while other shale shakers are designed to remove finer particles. Despite the use of shakers, a certain amount of drilling mud, which can contain hazardous oil, adheres to the drill cuttings. Other solids separators include mud cleaners and centrifuges.

After solids separation, the drill cuttings are disposed as drilling waste and the reusable drilling fluid is returned to a mud pit where it can be recycled into the well bore. In addition, over time the post-separation drilling fluid becomes too contaminated with fine solids particles that cannot be removed through typical separation techniques. Once the drilling fluid is no longer recyclable, it also becomes drilling waste and must be disposed.

Disposal of the drilling waste includes transportation of the drilling waste from the drilling site to a processing facility in a container. After being run through the solids separators, the drilling waste comprising the drill cuttings and residual drilling fluid may be placed in holding containers. The drilling waste may also include “recovered” drilling fluid that is not reusable in the well. After being placed in containers, the drilling waste is then loaded onto either a truck or a boat for transportation to the processing facility. If left alone in the containers for a long enough period, however, the drilling cuttings adhere to the insides of the containers. The normal movement associated with transporting the drilling waste also aids the cuttings to adhere to the insides of the containers. One method of removing the drilling cuttings from the containers is by washing the drilling cuttings out with large amounts of water. The additional water, however, creates other problems of added volume, bulk, and messiness. Additionally, if the drilling waste is to be run through a thermal drier, the added water decreases the efficiency of the thermal drying process by adding volume to the waste product. An apparatus for processing deleterious material on a floating vessel during transportation includes equipment for the slurrification and agitation of the deleterious material as disclosed in U.S. Pat. No. 6,745,856 assigned to the same assignee as the current application and the contents of which are hereby incorporated by reference. The addition of fluid to the deleterious material, increases volume and bulk, as described above.

### SUMMARY

One embodiment of the method of containing drilling waste comprises moving the drilling waste in a container so as to prevent at least a substantial portion of the drill cuttings from adhering to the inside of the container. Without the drill cuttings adhering to the inside of the container, the drilling waste may then be easily removed from the container by any suitable means. The drilling waste may include drilling fluid, oil, water, drill cuttings, or other substances. The method may be performed at any location, including the drilling site or the processing facility. The drilling waste may be moved by any means and in any fashion so as to prevent at least a substantial portion of the drill cuttings from adhering the inside of the container. For example, the container may be rotated to tumble the drilling waste inside the container, thus preventing the drill cuttings from adhering to the inside of the container.

Another embodiment of the method of containing drilling waste comprises moving the drilling waste in a container so as to prevent at least a substantial portion of the drill cuttings from adhering to the inside of the container during transportation of the drilling waste. For example, the drilling waste may be moved during transportation from the well site on a boat or a motor vehicle to a processing facility.

Thus, the embodiments comprise a combination of features and advantages that overcome the problems of prior art devices. The various characteristics described above, as well as other features, will be readily apparent to those skilled in the art upon reading the following detailed description of the embodiments, and by referring to the accompanying drawings.

### BRIEF DESCRIPTION OF THE DRAWINGS

For a more detailed description of the embodiments, reference will now be made to the following accompanying drawings:

FIG. 1 is an elevation view of a drilling waste container on a drilling rig;

FIG. 2 is a perspective view of the drilling waste container;

FIG. 3 is an elevation view of a drilling waste container on a boat; and

FIG. 4 is an elevation view of a drilling waste container on a motor vehicle.

### DETAILED DESCRIPTION OF THE EMBODIMENTS

The present invention relates to containing drilling waste material and includes embodiments of different forms. The drawings and the description below disclose specific embodiments of the present invention with the understanding that the embodiments are to be considered an exemplification of the principles of the invention, and are not intended to limit the invention to that illustrated and described. Further, it is to be fully recognized that the different teachings of the embodiments discussed below may be employed separately or in any suitable combination to produce desired results.

One embodiment of the method of containing drilling waste comprises moving the drilling waste in a container so as to prevent at least a substantial portion of the drill cuttings, such as at least 80%, from adhering to the inside of the container. Although not all of the drill cuttings need be prevented from adhering to the inside of the container, all of the drill cuttings may be prevented from adhering to the inside of the container as well. The container may be any suitable type or shape (e.g., cylindrical). The drilling waste may include any combination of drilling fluid, oil, water, drill cuttings, or other substances. Additionally, the drilling waste may include material directly from the well or material that has been processed through a solids separator. The drilling waste may be moved in the container by any means and in any fashion. As non-limiting examples, the drilling waste may be tumbled, shaken, vibrated, and/or stirred. The drilling waste may also be moved in the container continuously or intermittently or at a constant rate or varying rates. Additionally, the container may be maintained air-tight or left open to the atmosphere. The method may also be performed at any location, including at the drilling site or at a processing facility. The drilling waste may also be emptied from the container by any means. For example, the drilling waste may be dumped, poured, pumped, vacuumed, or even blown out of the container.

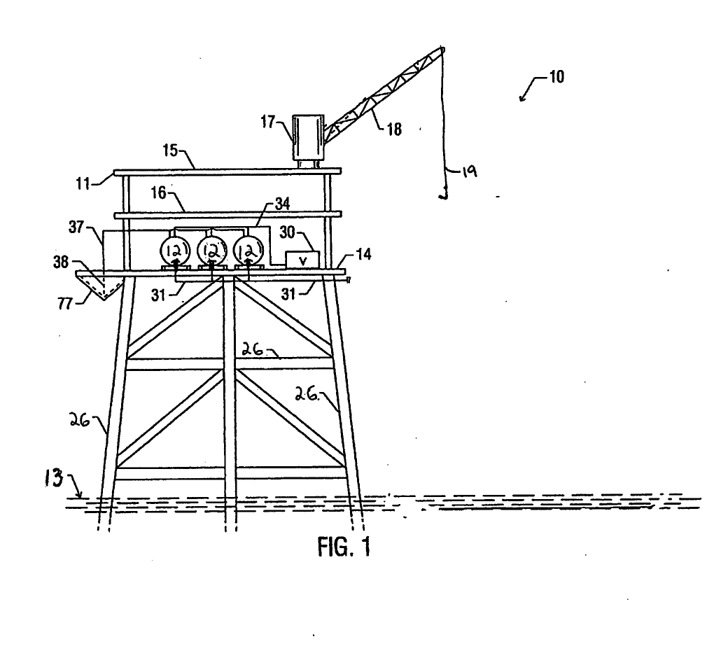

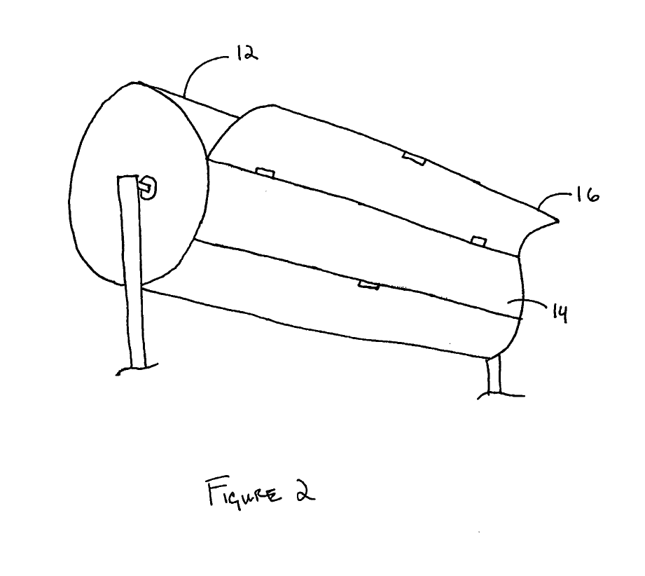

As an example of the first embodiment, FIGS. 1 and 2 show drilling waste containers 12 on a drilling rig 10. The drilling rig 10 may also be a workover rig or any other type of production facility for a well. The drilling rig 10 includes an offshore oil and gas well drilling platform 11. The platform 11 can include a lower support structure or jacket 26 that extends to the ocean floor and a short distance above the water surface 13. The platform 11 can also be a jack-up rig, a semi-submersible, a production barge, or a drilling barge. A superstructure is mounted upon the jacket 26. The superstructure includes a number of spaced apart decks including lower deck 14, upper deck 15, and an intermediate deck 16. Such a platform 11 typically includes a lifting device such as crane 17 having boom 18 and lifting line 19. The drilling rig 10 includes one or more tanks 12 for holding drilling waste and other materials that have been removed from the well during drilling. In general, the concept of an offshore well platform is well known in the art and no particular configuration of the rig platform or its equipment is required.

During well operations, a receptacle on rig 11 such as trough 77 receives drilling waste from the well. Material in trough 77 is then moved to one or more of the containers 12 using a vacuum unit 30 connected to suction manifold 34 via a suction line. An additional suction manifold 37 communicates with each of the containers 12 and with trough 77 via suction intake 38. In this fashion, valving enables drilling waste to be transmitted to any selected container 12. In addition, other transfer equipment, such as pumps, pneumatic transfer systems, and mechanical transfer systems such as screw conveyors may be used to transfer the drilling waste instead of vacuums.

The containers 12, for example, may be commercial cement mixers with an eight cubic meter capacity. As an example, approximately five cubic meters of oil based drilling fluid cuttings are inserted into each of the containers 12 through any suitable means. The containers 12 may be of any suitable size capacity, however, including for example between 100 and 1000 barrels. Once the drilling waste is in the containers 12, the containers 12 rotate to tumble the drilling waste inside. For example, the containers 12 rotate at approximately two revolutions per minute. The containers 12 may be rotated by any suitable means, such as by mechanical or electrical motors with gear and/or belt drives. As shown in FIG. 2, when desired the drilling waste may be dumped from the containers 12 through an opening 14 created by door 16 without any of the drilling waste adhering to the inside of the containers 12. Thus 100% of the drill cuttings are prevented from adhering to the inside of the container 12. The above example is not intended to be limiting in any way, but is merely offered for illustrative purposes.

Containing drilling waste is also particularly important during transportation from one location to another. Usually during transportation, the drilling waste in the container is only moved a minor amount, such as when the container is loaded onto or unloaded from the means of transportation. Also, the drilling waste may be moved a certain amount due to the motion of the transportation means. However, the movement is usually small so as to actually aid in the adherence of the drill cuttings to the inside surface of the container. Another embodiment of the method of containing drilling waste comprises moving the drilling waste in a container so as to prevent at least a substantial portion of the drill cuttings, such as at least 80%, from adhering to the inside of the container during the transportation of the drilling waste from one location to another.

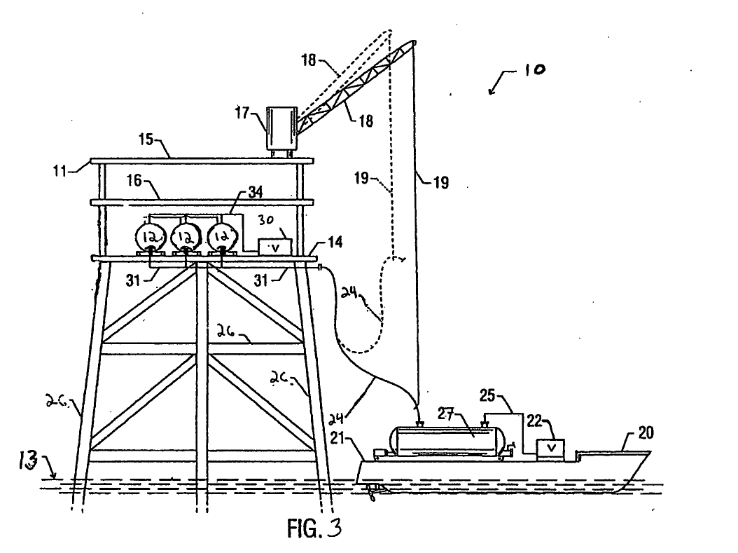

FIG. 3 shows a floating vessel 20 next to the rig 10 with a deck 21 that supports vacuum unit 22, vacuum lines 25, and one or more containers 27. However, no exact configuration of the equipment on vessel 20 is required. For example, other transfer equipment, such as pumps, pneumatic transfer systems, and mechanical transfer systems such as screw conveyors may be included on the vessel 20 to transfer the drilling waste instead of vacuums. In addition, the rig 10 may alternatively not have the containers 12 for moving the drilling waste and instead may only have normal storage tanks that do not move the drilling waste.

With the vessel 20 next to the rig 10, rig flowline 24 connects to the container 27 that is connected to vessel vacuum unit 22. The vacuum unit 22 then suctions the drilling waste from the rig 10 to the container 27 via vacuum lines 24 and 25. Once the transfer of the drilling waste is complete, the rig flowline 24 is disconnected from the container 27 and the vessel 20 then transports the drilling waste to a disposal site, such as an injection well. However, the disposal site may be a location other than an injection well. For example, the disposal site may be an on-shore disposal facility.

Normally during the transportation of the drilling waste on a boat, the drill cuttings adhere to the inside of the container and become difficult to remove. During the transportation of the drilling waste on the boat 20, however, the container 27 may be rotated or moved in any sufficient manner so as to prevent at least a substantial portion of the drill cuttings from adhering to the inside of the container 27. The drilling waste may then be easily removed at the destination site by any suitable means. Thus, moving the drilling waste prevents at least a substantial portion of the drill cuttings from adhering to the inside of the container 27.

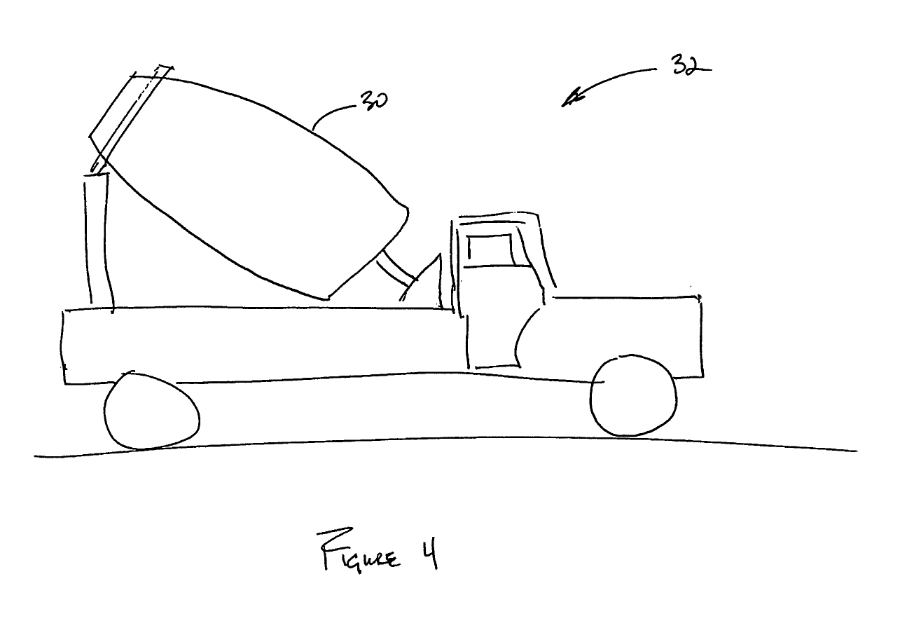

Additionally, containing drilling waste may also be a problem during transportation from an on-shore drilling rig. FIG. 4 shows a container 30 on a truck 32 for transporting the drilling waste from an on-shore drilling rig to an on-shore processing facility or some other location. As with transportation on a boat, transportation of the drilling waste on a truck causes the drill cuttings to adhere to the inside of the container and become difficult to remove. During the transportation of the drilling waste on the truck 32, however, the container 30 may be rotated or moved in any sufficient manner so as to prevent at least a substantial portion of the drill cuttings from adhering to the inside of the container 30. Thus, moving the drilling waste prevents at least a substantial portion of the drill cuttings from adhering to the inside of the container 30.

While specific embodiments have been shown and described, modifications can be made by one skilled in the art without departing from the spirit or teaching of this invention. The embodiments as described are exemplary only and are not limiting. Many variations and modifications are possible and are within the scope of the invention. Accordingly, the scope of protection is not limited to the embodiments described, but is only limited by the claims that follow, the scope of which shall include all equivalents of the subject matter of the claims.

What is claimed is:

1. A method of containing drilling waste comprising:
placing drilling waste comprising drill cuttings into a container; and
moving the drilling waste in the container to prevent at least a substantial portion of the drill cuttings from adhering to the inside surface of the container.

2. The method of claim 1 further comprising opening the container to the atmosphere during the moving of the drilling waste.

3. The method of claim 1 further comprising maintaining the container air-tight during the moving of the drilling waste.

4. The method of claim 1 further comprising transporting the container on a boat.

5. The method of claim 1 further comprising transporting the container on a motor vehicle.

6. The method of claim 1 wherein the drilling waste is moved continuously in the container.

7. The method of claim 1 wherein the drilling waste is moved intermittently in the container.

8. The method of claim 1 wherein the drilling waste is moved at a constant rate.

9. The method of claim 1 wherein the drilling waste is moved at varying rates.

10. The method of claim 1 further comprising rotating the container to tumble the drilling waste inside the container.

11. A method of containing drilling waste comprising:
placing drilling waste comprising drill cuttings into a container;
rotating the container to tumble the drilling waste inside the container to prevent at least a substantial portion of the drill cuttings from adhering to the inside surface of the container; and
transporting the container from a first location to a second location.

12. The method of claim 11 further comprising opening the container to the atmosphere during the moving of the drilling waste.

13. The method of claim 11 further comprising maintaining the container air-tight during the moving of the drilling waste.

14. The method of claim 11 wherein the rotating step is performed continuously.

15. The method of claim 11 wherein the rotating step is performed intermittently.

16. The method of claim 11 wherein the container rotates at a constant rate.

17. The method of claim 11 wherein the container rotates at varying rates.

18. The method of claim 11 wherein the transporting step comprises transporting the container is transported on a boat.

19. The method of claim 11 wherein the transporting step comprises transporting the container is transported on a motor vehicle.
